(19) United States
(12) Patent Application Publication
(10) Pub. No.: US 2024/0062526 A1
(43) Pub. Date: Feb. 22, 2024

(54) METHOD FOR TRAINING NEURAL NETWORK AND DEVICE THEREOF

(71) Applicant: Lunit Inc., Seoul (KR)

(72) Inventors: Weonsuk LEE, Seoul (KR); Hyeonsoo Lee, Seoul (KR); Gunhee Nam, Seoul (KR); Taesoo Kim, Seoul (KR)

(21) Appl. No.: 18/384,421

(22) Filed: Oct. 27, 2023

Related U.S. Application Data
(63) Continuation-in-part of application No. 16/842,435, filed on Apr. 7, 2020, now Pat. No. 11,823,056.

(30) Foreign Application Priority Data
Oct. 28, 2019 (KR) 10-2019-0134348

(51) Int. Cl. G06V 10/774; G06V 10/77; G06V 10/82

(52) U.S. Cl. CPC G06V 10/774; G06V 10/7715; G06V 10/82; G06V 2201/03

(57) ABSTRACT

Provided is a method for training a neural network and a device thereof. The method for training a neural network with three-dimensional (3D) training image data comprising a plurality of two-dimensional (2D) training image data, comprises: training a first convolutional neural network (CNN) with the plurality of 2D training image data, wherein the first convolutional neural network comprises 2D convolutional layers; and training a second convolutional neural network with the 3D training image data, wherein the second convolutional neural network comprises the 2D convolutional layers and 3D convolutional layers configured to receive an output of the 2D convolutional layers as an input.

### CROSS-REFERENCE TO RELATED APPLICATIONS

This application is a continuation-in-Part of U.S. application Ser. No. 16/842,435, filed Apr. 7, 2020, which claims the priority of Korean Patent Application No. 10-2019-0134348, filed on Oct. 28, 2019, in the Korean Intellectual Property Office, the disclosures of each of which are hereby incorporated by reference in their entireties.

### FIELD OF THE DISCLOSURE

The present invention relates to a method for training a neural network and a device thereof. In particular, the present invention relates to a method for training a neural network with three-dimensional (3D) images and a device to which the method is applied.

### BACKGROUND

Neural networks are machine learning models that simulate the neuron structure of a human. A neural network consists of one or more layers, and the output data of each layer is used as an input to the next layer. Recently, researches on the utilization of a deep neural network composed of a plurality of layers have been actively conducted, and the deep neural network has been playing a crucial role in enhancing the performance of recognition in various fields such as speech recognition, natural language processing, lesion diagnosis, and so on.

A deep neural network comprises a large number of hidden layers, and accordingly, can be trained with a variety of nonlinear relationships. However, training a neural network with 3D images of high resolution such as digital breast tomosynthesis (DBT) as input causes various difficulties and problems due to the amount of computation, memory usage, and the like.

Furthermore, in the case that the resolution of 3D images is reduced or a small network is used to overcome the limitations of memory, the performance of the neural network may be degraded.

### SUMMARY OF THE INVENTION

It is an object of the present invention to provide a method for training a neural network capable of training a neural network with 3D images.

It is another object of the present invention to provide a computer program stored in a computer-readable recording medium capable of training a neural network with 3D images.

It is yet another object of the present invention to provide a device for training a neural network capable of training a neural network with 3D images.

Objects to be achieved by the present invention are not limited to the list described above, and other objects that have not been mentioned will be clearly understood by a person having ordinary skill in the art from the following description.

A method is provided for training a neural network in accordance with some embodiments of the present invention to achieve the objects described above, and the method for training a neural network with three-dimensional (3D) training image data comprising a plurality of two-dimensional (2D) training image data, comprises: training a first convolutional neural network (CNN) with the plurality of 2D training image data, wherein the first convolutional neural network comprises 2D convolutional layers; and training a second convolutional neural network with the 3D training image data, wherein the second convolutional neural network comprises the 2D convolutional layers and 3D convolutional layers configured to receive an output of the 2D convolutional layers as an input.

A computer program to which a method for training a neural network is applied in accordance with some embodiments of the present invention to achieve another object described above executes, in combination with a computing device: a step of training a first convolutional neural network (CNN) with first patch image data included in each of a plurality of 2D training image data, wherein the first convolutional neural network comprises 2D convolutional layers, the 2D convolutional layers comprise first convolutional layers and second convolutional layers configured to receive an output of the first convolutional layers as an input, and the plurality of 2D training image data are included in 3D training image data; a step of training the first convolutional neural network with all of the plurality of 2D training image data, wherein parameters of the first convolutional layers are fixed according to a result of training the first convolutional neural network with the first patch image data; a step of training a second convolutional neural network with the 3D training image data, wherein the second convolutional neural network comprises the 2D convolutional layers and 3D convolutional layers configured to receive an output of the 2D convolutional layers as an input; and a step of fixing parameters of at least some of the 2D convolutional layers according to a training result of the first convolutional neural network.

A device for training a neural network in accordance with some embodiments of the present invention to achieve yet another object described above comprises: a storage unit having a computer program stored therein; a memory unit into which the computer program is loaded; and a processing unit for executing the computer program, wherein the computer program comprises: an operation of training a first convolutional neural network (CNN) with a plurality of 2D training image data, wherein the first convolutional neural network comprises 2D convolutional layers, and the plurality of 2D training image data are included in 3D training image data; and an operation of training a second convolutional neural network with the 3D training image data, wherein the second convolutional neural network comprises the 2D convolutional layers and 3D convolutional layers configured to receive an output of the 2D convolutional layers as an input, and parameters of at least some of the 2D convolutional layers are fixed according to a training result of the first convolutional neural network.

A method is provided for training a neural network in accordance with some embodiments of the present invention to achieve yet another object described above, and the method for training a neural network with three-dimensional (3D) training image data comprising a plurality of two-dimensional (2D) training image data, comprises: a spatial information learning stage for learning spatial features of the plurality of 2D training image data; and a context information learning stage for learning context information between the plurality of 2D training image data by combining the spatial features of each of the plurality of 2D training image data.

### BRIEF DESCRIPTION OF THE DRAWINGS

FIG. 1 is a block diagram for illustrating a device for training a neural network according to some embodiments of the present invention.

FIG. 2 is a flowchart for illustrating a method for training a neural network and a device thereof according to some embodiments of the present invention.

FIG. 3 is a conceptual diagram for illustrating a method for two-dimensionally training a neural network in a method for training a neural network and device thereof according to some embodiments of the present invention.

FIG. 4 is a conceptual diagram for illustrating a method for three-dimensionally training a neural network in a method for training a neural network and device thereof according to some embodiments of the present invention.

FIG. 5 is a conceptual diagram for illustrating a method for training a neural network and a device thereof according to some embodiments of the present invention.

FIG. 6 is a flowchart for illustrating in detail a method for training a first convolutional neural network shown in FIG. 2.

FIG. 7 is a diagram for illustrating first patch image data of 2D image data.

FIG. 8 is a conceptual diagram for illustrating training a first convolutional neural network with the first patch image data.

FIG. 9 is a conceptual diagram for illustrating training the first convolutional neural network with all of the 2D image data.

FIG. 10 is a flowchart for illustrating a method for training a neural network and a device thereof according to some embodiments of the present invention.

FIG. 11 is a diagram for illustrating second patch image data of the 2D image data.

FIG. 12 is a conceptual diagram for illustrating training a first convolutional neural network with the second patch image data.

FIG. 13 is a conceptual diagram for illustrating training the first convolutional neural network with all of the 2D image data.

FIG. 14 is a block diagram for illustrating a method for training a neural network and a device thereof according to some embodiments of the present invention.

FIG. 15 is a conceptual diagram for illustrating a method for two-dimensionally training the neural network in the method for training a neural network and device thereof shown in FIG. 14.

FIG. 16 is a flowchart for illustrating a method for training a neural network and a device thereof according to some embodiments of the present invention.

FIG. 17 is a diagram for illustrating frame selection for 3D image data according to some embodiments of the present invention.

FIG. 18 is a diagram for illustrating AI model switching according to some embodiments of the present invention.

FIG. 19 is a conceptual diagram for illustrating adaptation of modality-specific parameters according to some embodiments of the present invention.

FIG. 20 is a diagram for illustrating a neural network training and inference method based on frame selection for 3D images according to some embodiments of the present invention.

FIG. 21 is a diagram for illustrating a neural network training and inference method based on frame selection for 3D images according to some embodiments of the present invention.

### DETAILED DESCRIPTION OF THE PREFERRED EMBODIMENTS

The advantages and features of the disclosed embodiments and methods of achieving them will be apparent when reference is made to the embodiments described below in conjunction with the accompanying drawings. However, the present disclosure is not limited to the embodiments disclosed below but may be implemented in a variety of different forms, and the present embodiments are provided only to make the present disclosure complete and are merely provided to fully convey the scope of the invention to those having ordinary skill in the art.

Terms used herein will be briefly described, and then the disclosed embodiments will be described in detail.

Although the terms used herein have been chosen as generic terms that are widely used at present taking into account the functions of the present disclosure, they may vary depending on the intentions of those having ordinary skill in the art, or precedents, the emergence of new technology, and the like. Further, there may be terms arbitrarily selected by the applicant in some cases, and in that case, the meaning thereof will be described in detail in the description of the invention. Therefore, the terms used in the present disclosure should be defined based on the meanings of the terms and the contents throughout the present disclosure, rather than the simple names of the terms.

A singular-expression in the present specification also encompasses a plural-expression unless clearly indicated in the context that it is singular. Likewise, plural-expressions encompass singular expressions unless clearly indicated in the context that they are plural.

When a part is said to “include” some component throughout the specification, this means that it does not exclude other components but may further include other components unless specifically stated to the contrary.

Further, as used herein, the term “unit” refers to a software or hardware component, and a “unit” performs some functions. However, a “unit” is not meant to be limited to software or hardware. A “unit” may be configured to be in an addressable storage medium and may be configured to operate one or more processors. Thus, as an example, a “unit” encompasses components such as software components, object-oriented software components, class components, and task components, processes, functions, properties, procedures, subroutines, segments of a program code, drivers, firmware, microcode, circuits, data, databases, data structures, tables, arrays, and variables. The functions provided within components and “units” may be combined into a smaller number of components and “units” or further divided into additional components and “units.”

According to an embodiment of the present disclosure, a “unit” may be implemented with a processor and a memory. The term “processor” should be construed broadly to encompass general-purpose processors, central processing units (CPUs), microprocessors, digital signal processors (DSPs), controllers, microcontrollers, state machines, and the like. In some environments, a “processor” may refer to an application-specific integrated circuit (ASIC), a programmable logic device (PLD), a field-programmable gate array (FPGA), or the like. The term “processor” may also refer to a combination of processing devices such as, for example, a combination of a DSP and a microprocessor, a combination of a plurality of microprocessors, a combination of one or more microprocessors coupled with a DSP core, or a combination of any other such components.

The term “memory” should be construed broadly to encompass any electronic component capable of storing electronic information therein. The term “memory” may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. If a processor can read and/or write information from/to memory, the memory is said to be in electronic communication with the processor. The memory integrated into a processor is in electronic communication with the processor.

In this specification, a neural network is a term encompassing all kinds of machine learning models designed to mimic neural structures. For example, the neural network may comprise all kinds of neural network based models, such as an artificial neural network (ANN), a convolutional neural network (CNN), DNN (Deep Neural Network), DFN (Deep Feedforward Network), Transformer, RNN(Recurrent Neural Network), LSTM (Long Short-Term Memory), MLP (Multi-Layer Perceptron) and the like.

For convenience, the following describes a method for training a neural network and a device thereof according to some embodiments of the present invention based on a convolutional neural network.

Hereinafter, embodiments will be described in greater detail with reference to the accompanying drawings so that those having ordinary skill in the art to which the present disclosure pertains may readily implement the same. Further, parts that are not relevant to the description will be left out of the drawings to describe the present disclosure clearly.

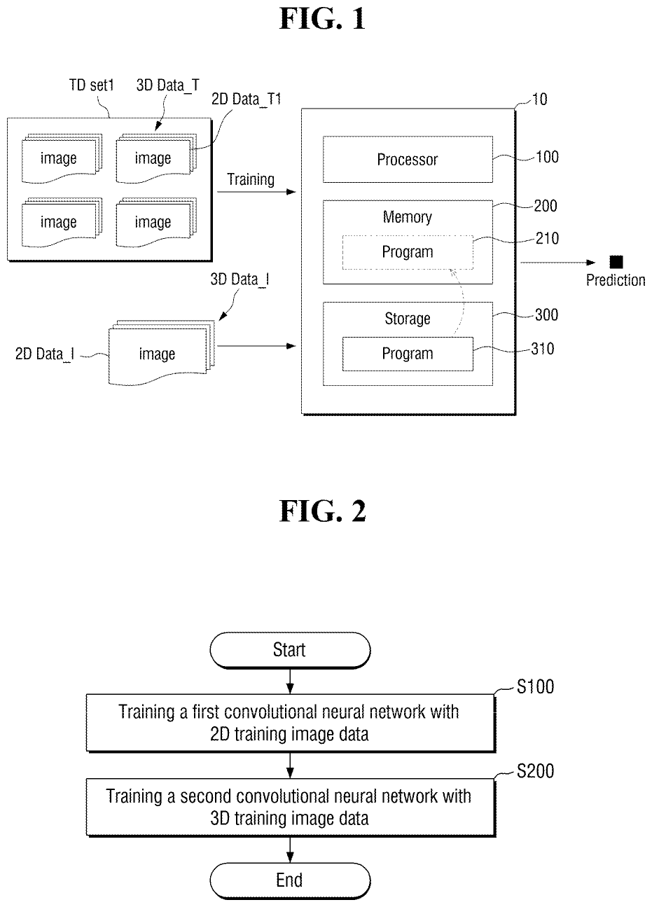

Below, a method for training a neural network and a device thereof according to some embodiments of the present invention will be described with reference to FIG. 1 to FIG. 4.

FIG. 1 is a block diagram for illustrating a device for training a neural network according to some embodiments of the present invention.

Referring to FIG. 1, a device 10 for training a neural network according to some embodiments of the present invention may receive a first training data set TD set1. In this case, the first training data set TD set1 may comprise at least one three-dimensional (3D) training image data 3D data_T. The 3D training image data 3D data_T may comprise two-dimensional (2D) training image data 2D data_T1. A plurality of 2D training image data 2D data_T1 may constitute a 3D training image data 3D data_T. Accordingly, the plurality of 2D training image data 2D data_T1 may form the 3D training image data 3D data_T. In other words, the 3D training image data 3D data_T may be data formed by continuously arranging the 2D training image data 2D data_T1.

The device 10 for training a neural network may train the neural network therein with the first training data set TD set1. Here, the training may mean a process of determining parameters of functions in various layers existing in the neural network. The parameters may comprise weights and biases of the functions. Once the parameters are determined through training, the device 10 for training a neural network may receive 3D inference image data 3D Data_I and may perform a prediction with the parameters.

In this case, the 3D inference image data 3D Data_I may comprise a plurality of 2D inference image data 2D Data_I as with the 3D training image data 3D data_T. However, the present embodiment is not limited thereto, and 2D image data may also be received as an input for prediction.

In this case, the 3D training image data 3D data_T and the 3D inference image data 3D data_I may be at least one of a digital breast tomosynthesis (DBT) image and a computed tomography (CT) image. However, the present embodiment is not limited thereto. All 2D images included in the 3D training image data 3D data_T may be used as training data, or selected 2D images (e.g., images in which lesions are present) from the 3D training mage data may be used as training data. All 2D images included in the 3D inference image data 3D data_I may be used as inference data, or selected 2D images from the 3D inference image data may be used as inference data. That is, the device 10 for training a neural network may perform predictions about the 3D inference image data 3D data_I from all 2D images included in the 3D inference image data 3D data_I or the selected 2D images.

The device 10 for training a neural network may perform multi-stage learning to train the neural network with the 3D training image data 3D data_T. That is, the neural network may be trained separately in a plurality of stages with the 3D training image data 3D data_T, instead of being trained all at once with the 3D training image data 3D data_T.

More specifically, the device 10 for training a neural network may train the neural network with the 3D training image data 3D data_T through a spatial information learning stage and a context information learning stage.

The spatial information learning stage may be a step of learning spatial features of the 2D training image data 2D data_T1 constituting the 3D training image data 3D data_T.

The spatial information learning stage may be further divided into several stages. Specifically, the spatial information learning stage may comprise a patch-level training stage and an image-level training stage.

The patch-level training stage may be a stage of learning the spatial features by using a patch that is part of the 2D training image data 2D data_T1 as an input. The image-level training stage may be a stage of learning the spatial features using all of the 2D training image data 2D data_T1.

The context information learning stage may be a step of combining and finally determining the spatial features in addition to learning the spatial features of the 2D training image data 2D data_T1, and may be a step of identifying context information between the respective 2D training image data 2D data_T1. In this way, the 3D training image data 3D data_T may be learned through 3D convolution in the context information learning stage.

The device 10 for training a neural network may comprise a processor 100, a memory 200, and a storage 300. The processor 100 may load a computer program 310 stored in the storage 300 into the memory 200 and execute it. The processor 100 controls the overall operation of respective components of the device 10 for training a neural network. The processor 100 may comprise a central processing unit (CPU), a microprocessor unit (MPU), a microcontroller unit (MCU), a graphics processing unit (GPU), or any type of processor well known in the art. The device 10 for training a neural network may comprise one or more processors 100.

The memory 200 stores various data, commands, and/or information therein. The memory 200 may load one or more computer programs 310 from the storage 300 to execute methods/operations in accordance with various embodiments of the present disclosure. The memory 200 may be implemented with volatile memory such as random access memory (RAM), but the technical scope of the present disclosure is not limited thereto.

When the memory 200 loads the computer program 310, the processor 100 may execute operations and instructions within the computer program 310.

The storage 300 may store the computer program 310 therein. The storage 300 may store therein data for the processor 100 to load and execute. The storage 300 may comprise non-volatile memory such as, for example, read-only memory (ROM), erasable programmable ROM (EPROM), electrically erasable programmable ROM (EEPROM), flash memory, and the like, a hard disk, a removable disk, or any type of computer-readable recording medium well known in the art to which the present invention pertains. However, the present embodiment is not limited thereto.

The computer program 310 may comprise an operation for training the device 10 for training a neural network with the first training data set TD set1 and for performing prediction corresponding to the 3D inference image data 3D Data_I.

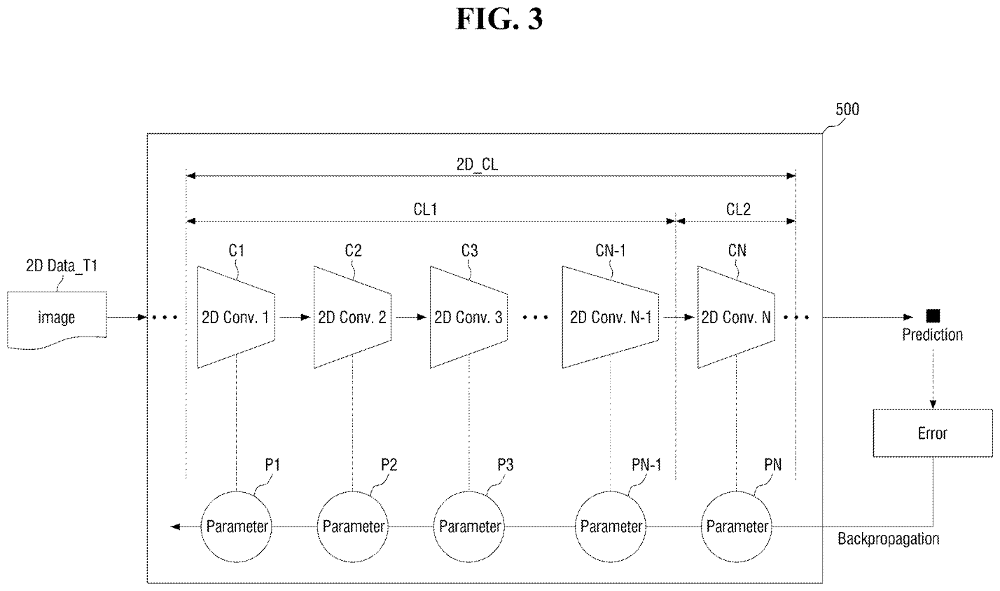

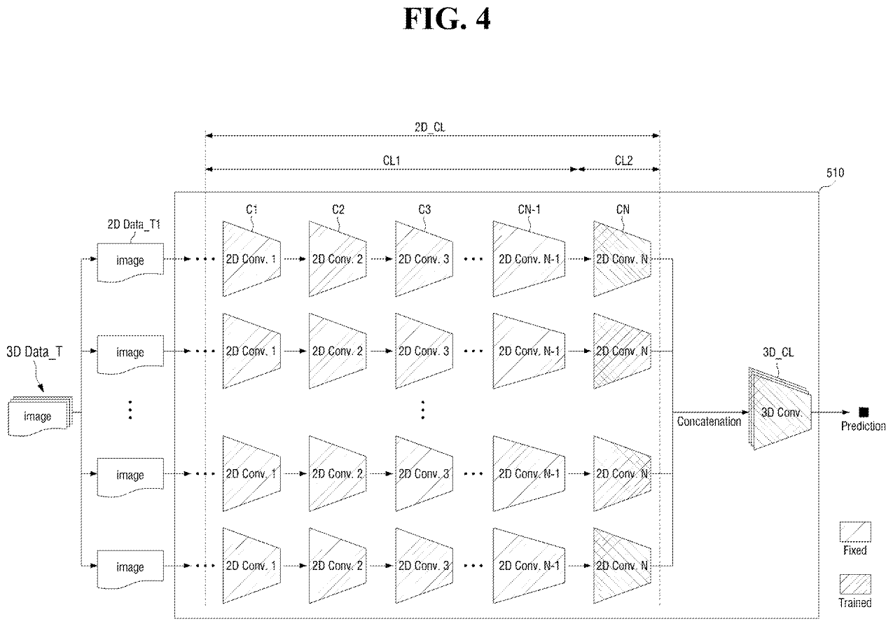

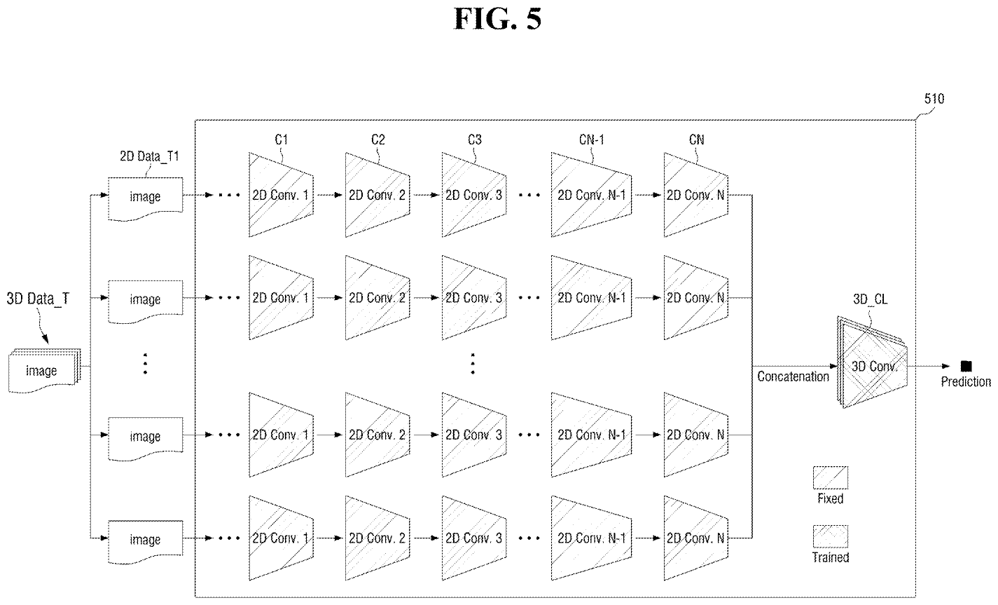

FIG. 2 is a flowchart for illustrating a method for training a neural network and a device thereof according to some embodiments of the present invention, FIG. 3 is a conceptual diagram for illustrating a method for two-dimensionally training a neural network in a method for training a neural network and device thereof according to some embodiments of the present invention. FIG. 4 is a conceptual diagram for illustrating a method for three-dimensionally training a neural network in a method for training a neural network and device thereof according to some embodiments of the present invention.

Referring to FIG. 2, a first convolutional neural network is trained using 2D image data in S100.

Specifically, referring to FIG. 1 and FIG. 3, the first convolutional neural network 500 may be a convolutional neural network (CNN) implemented with the device 10 for training a neural network according to some embodiments of the present invention.

The step of training the first convolutional neural network 500 may correspond to the spatial information learning stage of the multi-stage learning described above. That is, the step S100 may be a step in which the first convolutional neural network 500 extracts feature maps of the 2D training image data 2D data_T1 constituting the 3D training image data 3D data_T, respectively, and learns spatial information thereof.

The first convolutional neural network 500 may receive the 2D training image data 2D data_T1, to thereby perform prediction. The first convolutional neural network 500 may comprise a plurality of 2D convolutional layers 2D_CL. The 2D convolutional layers 2D_CL may be layers that perform convolution on the 2D training image data 2D data_T1. Though not shown in FIG. 3, the first convolutional neural network 500 may comprise at least one of a normalization layer, an activation layer, a pooling layer, and a fully-connected layer. However, the present embodiment is not limited thereto.

The 2D convolutional layers 2D_CL may comprise N number of 2D convolutional layers C1 to CN. Here, N may be a natural number. The N number of 2D convolutional layers C1 to CN may each perform convolution with a filter. This is to extract a feature map corresponding to the filter from the 2D training image data 2D data_T1.

Each of the N number of 2D convolutional layers C1 to CN may receive the output of the previous layer as an input. In other words, the N number of 2D convolutional layers C1 to CN may perform convolution sequentially. In this case, a layer located relatively ahead of the layers may be defined as a lower layer, and a layer located relatively behind may be defined as an upper layer.

The 2D convolutional layers 2D_CL may comprise first convolutional layers CL1 and second convolutional layers CL2. The output of the first convolutional layers CL1 may be an input to the second convolutional layers CL2. That is, the first convolutional layers CL1 may be lower layers relative to the second convolutional layers CL2. The other way around, the second convolutional layers CL2 may be upper layers relative to the first convolutional layers CL1.

Though FIG. 3 shows N−1 number of first convolutional layers CL1 and one second convolutional layer CL2, this is only an example and the present embodiment is not limited thereto. In other words, the number of the first convolutional layers CL1 and the second convolutional layers CL2 may vary as desired.

The value of the prediction derived at last may be compared with the value of the training output embedded in the 2D training image data 2D data_T1 in the form of a label. An error may mean a difference between the values of the training output and the prediction. The first convolutional neural network 500 may backpropagate an error to update parameters P1 to PN of the N number of 2D convolutional layers C1 to CN. Through this process, the first convolutional neural network 500 may be trained, or may learn. In other words, once the first convolutional neural network 500 is trained on all the 2D training image data 2D data_T1, the parameters P1 to PN may be determined.

Referring to FIG. 2 again, a second convolutional neural network is trained with 3D image data in S200.

The step of training the second convolutional neural network 510 may correspond to the context information learning stage of the multi-stage learning described above. That is, the step S200 may be a step in which the second convolutional neural network 510 extracts feature maps, respectively, of the 2D training image data 2D data_T1, then concatenates the extracted feature maps with one another, and learns context information therebetween through 3D convolution. Here, the 3D convolution is an example of an aggregator that aggregates information from feature maps and outputs a prediction.

In particular, referring to FIG. 1, FIG. 3, and FIG. 4, the second convolutional neural network 510 may be a convolutional neural network implemented with the device 10 for training a neural network according to some embodiments of the present invention. The second convolutional neural network 510 may comprise a 3D convolutional layer 3D_CL, in contrast to the first convolutional neural network 500. In addition, the second convolutional neural network 510 may comprise at least one of a normalization layer, an activation layer, a pooling layer, and a fully-connected layer, as with the first convolutional neural network 500 described above. However, the present embodiment is not limited thereto.

The second convolutional neural network 510 may receive the 3D training image data 3D data_T, to thereby perform prediction. In this case, the 3D training image data 3D data_T may be divided into a plurality of 2D training image data 2D data_T1. Each of the 2D training image data 2D data_T1 passes through the N number of 2D convolutional layers C1 to CN, as with the first convolutional neural network 500, and the feature maps that are the outputs of the former may be finally concatenated with one another to form a 3D feature map. The 3D feature map may be inputted to the 3D convolutional layer 3D_CL.

In other words, each of the 2D training image data 2D data_T1 constituting the 3D training image data 3D data_T passes in parallel or sequentially through the N number of 2D convolutional layers C1 to CN to produce outputs, and these outputs may be combined to be inputted to the 3D convolutional layer 3D_CL. The device 10 for training a neural network of the present embodiment may learn spatial information by the N number of 2D convolutional layers C1 to CN and may learn context information by the 3D convolutional layer 3D_CL.

However, the method of processing such 3D training image data 3D data_T may require a large amount of computation, and accordingly, the processing may not be possible if there is a limit to the capacity of the memory 200 of the device 10 for training a neural network. In particular, if the 3D training image data 3D data_T is a DBT image or a CT image of high resolution, a higher capacity of the memory 200 may be necessary.

To resolve this issue, the method for training a neural network and device thereof according to some embodiments of the present invention may first train the first convolutional neural network 500 with the 2D training image data 2D data_T1, and subsequently, train the second convolutional neural network 510 with the 3D training image data 3D data_T, instead of processing the 3D training image data 3D data_T directly.

At this time, the second convolutional neural network 510 may fix the parameters of at least some of the N number of 2D convolutional layers C1 to CN using the parameters P1 to PN determined in the first convolutional neural network 500, and may be trained using only the remaining 2D convolutional layers and the 3D convolutional layer 3D_CL. For example, out of the 2D convolutional layers 2D_CL, the parameters of the first convolutional layers CL1 may be fixed, and the parameters of the second convolutional layers CL2 may be used for training.

That is, backpropagation may be performed through the value of the prediction that has passed through the 3D convolutional layer 3D_CL to update the parameters of the second convolutional layers CL2 and the 3D convolutional layers 3D_CL. In this case, the parameters of the first convolutional layers CL1 may be fixed without being updated.

The parameters of the 2D convolutional layers 2D_CL of the first convolutional neural network 500 and the 2D convolutional layers 2D_CL of the second convolutional neural network 510 may have a relatively higher similarity at lower layers. Thus, in order to overcome the limitations of the memory 200, the parameters of the lower layers of the second convolutional neural network 510 may be fixed to the corresponding parameters of the first convolutional neural network 500, and only the upper layers may be used for training to minimize the usage of the memory 200.

Though FIG. 4 illustrates that the number of lower layers whose parameters are fixed, i.e., the first convolutional layers CL1 is N−1, and the number of upper layers whose parameters are used for training, i.e., the second convolutional layers CL2 is 1, the present embodiment is not limited thereto. As the number of lower layers whose parameters are fixed increases, the usage of the memory 200 can be reduced, and thus the method for training a neural network and device thereof according to the present embodiment may appropriately select the number of lower layers whose parameters are fixed in a range that does not decrease the performance of the neural network.

In this way, the second convolutional neural network 510 may minimize the usage of the memory 200 even when processing the 3D training image data 3D data_T. Accordingly, the device 10 for training a neural network may be smoothly operated even with a low capacity of the memory 200 without decreasing performance by using 3D training image data 3D data_T of high resolution.

Hereinafter, a method for training a neural network and a device thereof according to some embodiments of the present invention will be described with reference to FIGS. 1 and 5. Parts that may otherwise repeat the same description will be described briefly or omitted.

FIG. 5 is a conceptual diagram for illustrating a method for training a neural network and a device thereof according to some embodiments of the present invention.

Referring to FIGS. 1 and 5, the second convolutional neural network 510 of the device for training a neural network according to some embodiments of the present disclosure may fix the parameters of all of the 2D convolutional layers 2D_CL. Accordingly, the second convolutional neural network 510 may be trained only with the parameters of the 3D convolutional layer 3D_CL.

Accordingly, the parameters determined in the first convolutional neural network 500 that was trained earlier may be used as they are as the parameters of the 2D convolutional layers 2D_CL. In this way, the memory 200 may be used concentrated on training with the parameters of the 3D convolutional layer 3D_CL. The method for training a neural network and device thereof according to the present embodiment may minimize the usage of the memory 200 as such, to thereby readily learn the 3D image data of high resolution.

Hereinafter, a method for training a neural network and a device thereof according to some embodiments of the present invention will be described with reference to FIGS. 1, 2, and 6 to 9. Parts that may otherwise repeat the same description will be described briefly or omitted.

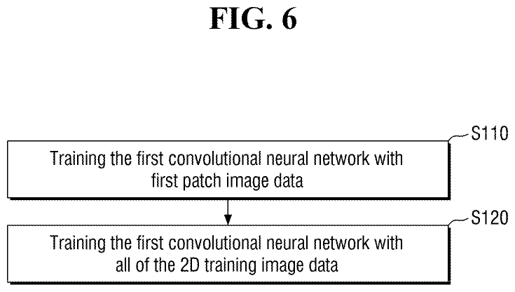

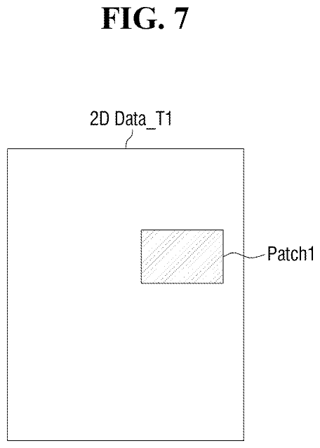

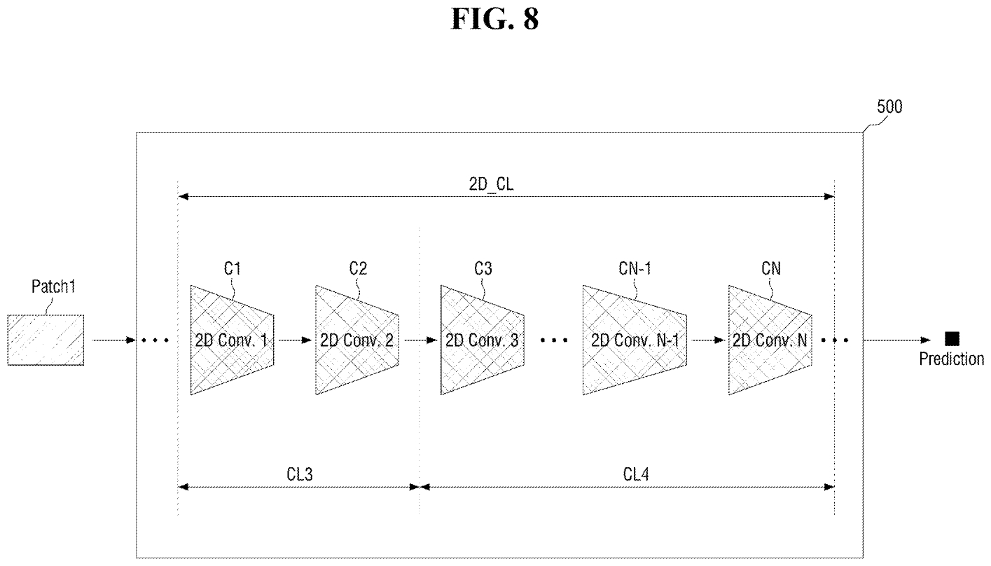

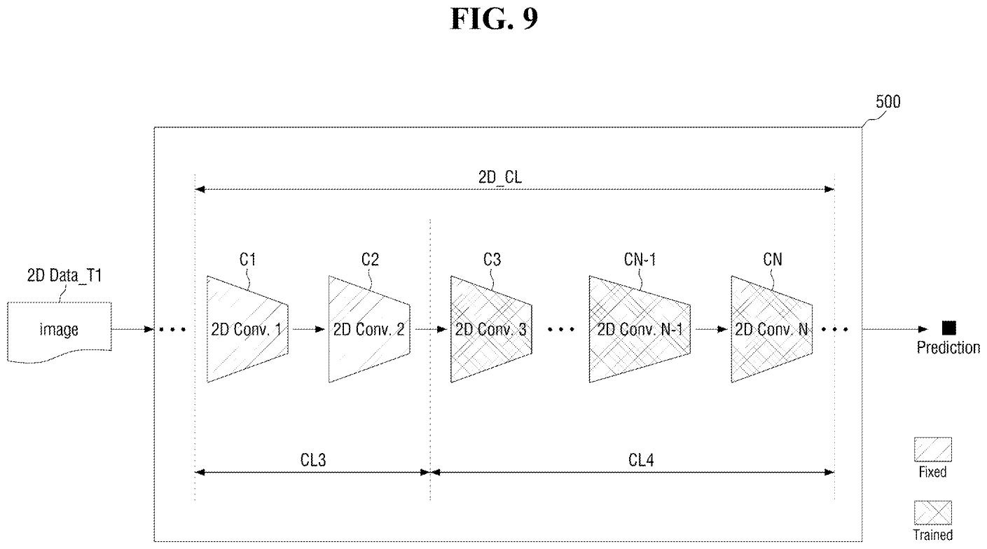

FIG. 6 is a flowchart for illustrating in detail a method for training the first convolutional neural network shown in FIG. 2, FIG. 7 is a diagram for illustrating first patch image data of the 2D image data. FIG. 8 is a conceptual diagram for illustrating training the first convolutional neural network with the first patch image data, FIG. 9 is a conceptual diagram for illustrating training the first convolutional neural network with all of the 2D image data;

Referring to FIGS. 2 and 6, a method for training a neural network according to some embodiments of the present invention trains the first convolutional neural network with the 2D training image data in S100. In this case, the step S100 of training the first convolutional neural network may be subdivided into two steps.

First, the first convolutional neural network is trained with first patch image data in Silo.

The step of training the first convolutional neural network 500 with the first patch image data Patch1 may correspond to the patch-level training stage of the spatial information learning stage described above. That is, the step S110 may be a step in which the first convolutional neural network 500 extracts feature maps of the first patch image data Patch1, respectively, and learns spatial information thereof.

Specifically, referring to FIG. 7, the first patch image data Patch1 may be included in the 2D training image data 2D data_T1. In other words, the first patch image data Patch1 may be data generated by cutting out part of the 2D training image data 2D data_T1. In this case, the first patch image data Patch1 may be generated from each of the plurality of 2D training image data 2D data_T1.

The first patch image data Patch1 may be data cut out at a random location from the 2D training image data 2D data_T1. Accordingly, the first patch image data Patch1 generated from each of the plurality of 2D training image data 2D data_T1 may be data acquired by cutting out a different location of each of the plurality of 2D training image data 2D data_T1. Of course, the present embodiment is not limited thereto. That is, the first patch image data Patch1 may be data acquired by cutting out the same location of each of the plurality of 2D training image data 2D data_T1. Sizes of the first patch image data Patch1 generated from each of the plurality of 2D training image data 2D data_T1 may be the same.

Referring to FIGS. 1 and 8, the first patch image data Patch1 may be used for training in the 2D convolutional layers 2D_CL of the first convolutional neural network 500. That is, the parameters of the 2D convolutional layers 2D_CL may be determined by prediction and backpropagation.

In this case, the 2D convolutional layers 2D_CL may comprise third convolutional layers CL3 and fourth convolutional layers CL4. The third convolutional layers CL3 may be lower layers at a lower position relative to the fourth convolutional layers CL4. In other words, the output of the third convolutional layers CL3 may be an input to the fourth convolutional layers CL4. Though FIG. 8 shows two third convolutional layers CL3 and N−2 number of fourth convolutional layers CL4, this is only an example and the present embodiment is not limited thereto. In other words, the number of the third convolutional layers CL3 and the fourth convolutional layers CL4 may vary as desired.

Since training the first convolutional neural network 500 with the first patch image data Patch1 uses smaller pixels as an input compared to the 2D training image data 2D data_T1 of high resolution, the usage of the memory 200 may be relatively small. Therefore, it may not be difficult to train the first convolutional neural network 500 with the first patch image data Patch1 even when the memory 200 is relatively small.

Referring to FIG. 6 again, the first convolutional neural network is trained with all of the 2D training image data in S120.

The step of training the first convolutional neural network 500 with all of the 2D training image data 2D data_T1 may correspond to the image-level training stage of the spatial information learning stage described above. That is, the step S120 may be a step in which the first convolutional neural network 500 extracts feature maps, respectively, of all of the 2D training image data 2D data_T1 and learns spatial information thereof.

Specifically, referring to FIG. 1 and FIG. 9, the first convolutional neural network 500 may receive all of the 2D training image data 2D data_T1, to thereby perform prediction. In the case that such 2D training image data 2D data_T1 is of high resolution as with a DBT image or a CT image, training with the 2D training image data 2D data_T1 all at once may require high usage of the memory 200.

In order to resolve this issue, the method for training a neural network and device thereof according to some embodiments of the present invention may perform training with the 2D training image data 2D data_T1 in several separate stages. In other words, the first convolutional neural network 500 may be first trained with the first patch image data Patch1 that is part of the 2D training image data 2D data_T1, and subsequently, the first convolutional neural network 500 may be trained again with all of the 2D training image data 2D data_T1.

At this time, the first convolutional neural network 500 may fix the parameters of some of the lower layers using the parameters determined in the first convolutional neural network 500 that was trained with the first patch image data Patch1, and may be trained using the remaining upper layers only. For example, out of the 2D convolutional layers 2D_CL, the parameters of the third convolutional layers CL3 may be fixed, and the parameters of the fourth convolutional layers CL4 may be used for training.

The method for training a neural network and device thereof according to the present embodiments may perform backpropagation through the value of the prediction that has passed through the 2D convolutional layers 2D_CL, to update the parameters of the fourth convolutional layers CL4. At this time, the parameters of the third convolutional layers CL3 may be fixed, and only the parameters of the fourth convolutional layers CL4 may be updated.

The parameters of the 2D convolutional layers 2D_CL of the first convolutional neural network 500 trained with the first patch image data Patch1 and the 2D convolutional layers 2D_CL of the first convolutional neural network 500 trained with the 2D training image data 2D data_T1 may have a relatively higher similarity at lower layers. Thus, in order to overcome the limitations of the memory 200, the parameters of the lower layers of the first convolutional neural network 500 to be trained with the 2D training image data 2D data_T1 may be fixed to the corresponding parameters of the first convolutional neural network 500 trained with the first patch image data Patch1, and only the upper layers may be used for training to minimize the usage of the memory 200.

Though FIG. 9 shows that the number of lower layers whose parameters are fixed, i.e., the third convolutional layers CL3 is 2, and the number of upper layers whose parameter are used for training, i.e., the fourth convolutional layers CL4 is N−2, the present embodiment is not limited thereto. As the number of lower layers whose parameters are fixed increases, the usage of the memory 200 can be reduced, and thus the method for training a neural network and device thereof according to the present embodiment may appropriately select the number of lower layers whose parameters are fixed in a range that does not decrease the performance of the neural network.

In this way, the memory 200 may be minimally used even in the step of processing the 2D training image data 2D data_T1.

Again, referring to FIG. 2, the second convolutional neural network is trained using the 3D image data in S200.

Hereinafter, a method for training a neural network and a device thereof according to some embodiments of the present invention will be described with reference to FIGS. 1, 2, 8, and 10 to 13. Parts that may otherwise repeat the same description will be described briefly or omitted.

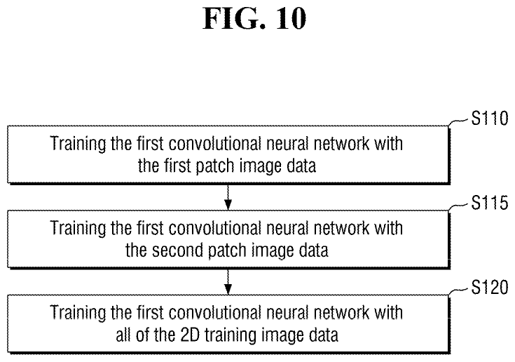

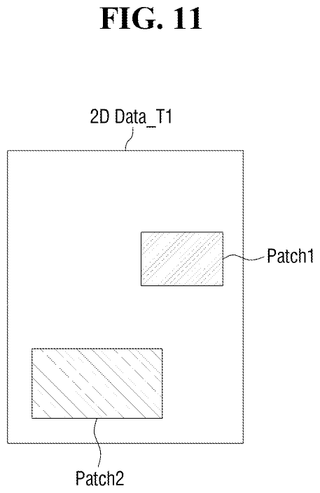

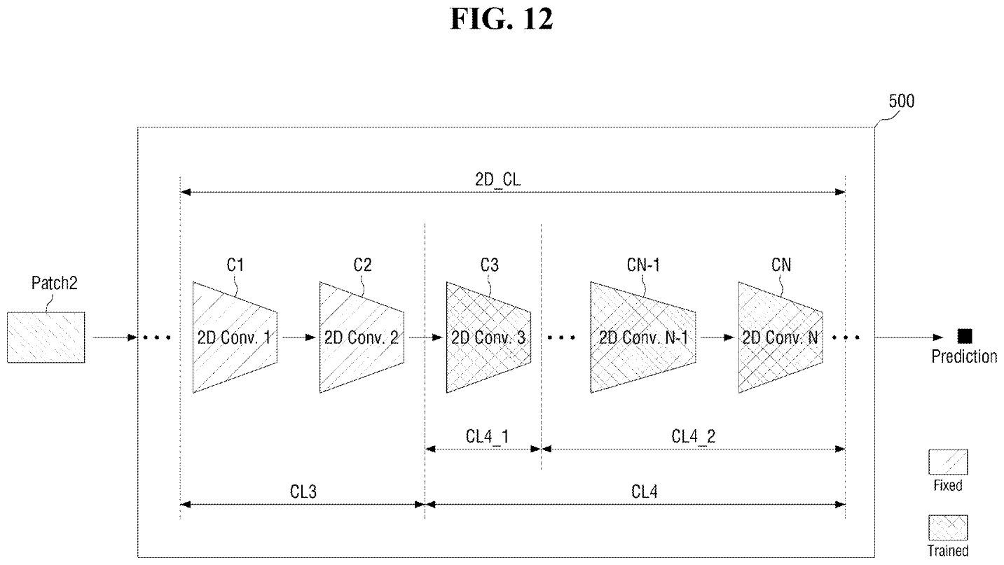

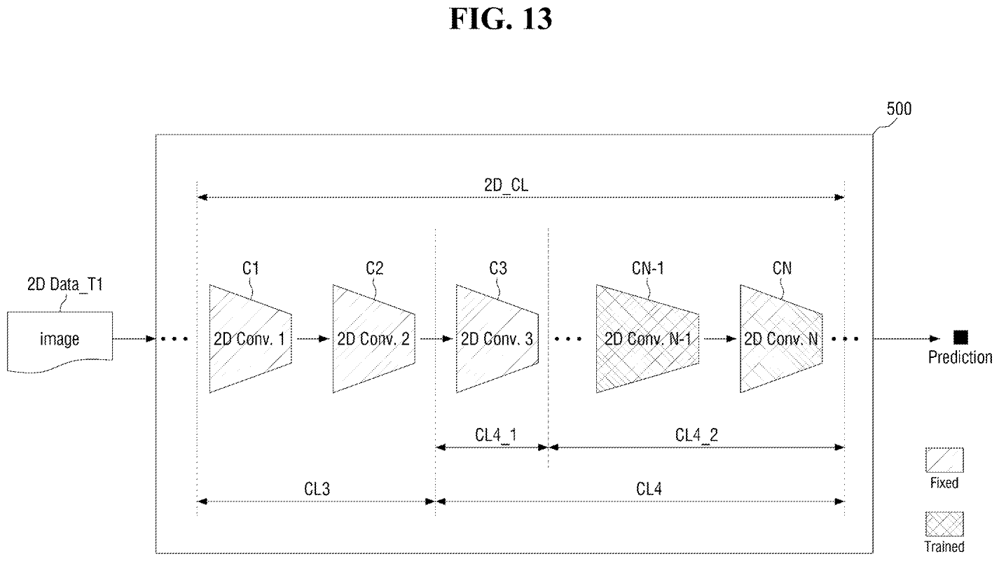

FIG. 10 is a flowchart for illustrating a method for training a neural network and a device thereof according to some embodiments of the present invention, and FIG. 11 is a diagram for illustrating second patch image data of the 2D image data. FIG. 12 is a conceptual diagram for illustrating training the first convolutional neural network with the second patch image data, and FIG. 13 is a conceptual diagram for illustrating training the first convolutional neural network with all of the 2D image data. FIG. 10 is a diagram for illustrating in detail the steps of training the first convolutional neural network of FIG. 2.

Referring to FIGS. 2 and 10, the method for training a neural network according to some embodiments of the present invention trains the first convolutional neural network with the 2D training image data in S100. In this case, the step S100 of training the first convolutional neural network may be subdivided into three steps.

First, the first convolutional neural network is trained with the first patch image data in S110. This is the same as that described in relation to FIG. 6.

Thereafter, the first convolutional neural network is trained with the second patch image data in S115.

Specifically, referring to FIG. 11, the second patch image data Patch2 may be included in the 2D training image data 2D data_T1. In other words, the second patch image data Patch2 may be data generated by cutting out part of the 2D training image data 2D data_T1. In this case, the second patch image data Patch2 may be generated from each of the plurality of 2D training image data 2D data_T1.

The second patch image data Patch2 may be data cut out at a random location from the 2D training image data 2D data_T1. Accordingly, the second patch image data Patch2 generated from each of the plurality of 2D training image data 2D data_T1 may be data obtained by cutting out a different location of each of the plurality of 2D training image data 2D data_T1. Of course, the present embodiment is not limited thereto. That is, the second patch image data Patch2 may be data obtained by cutting out the same location of each of the plurality of 2D training image data 2D data_T1. Sizes of the second patch image data Patch2 generated from each of the plurality of 2D training image data 2D data_T1 may be the same.

The size of the second patch image data Patch2 may be larger than that of the first patch image data Patch1. Since the second patch image data Patch2 may be data cut out at a random location of the 2D training image data 2D data_T1 as with the first patch image data Patch1, the second patch image data Patch2 may or may not overlap the first patch image data Patch1.

Referring to FIG. 12, the second patch image data Patch2 may be used for training in the 2D convolutional layers 2D_CL of the first convolutional neural network 500. That is, the parameters of the 2D convolutional layer 2D_CL may be determined by prediction and backpropagation.

The 2D convolutional layers 2D_CL may comprise third convolutional layers CL3 and fourth convolutional layers CL4. The third convolutional layers CL3 may be lower layers to the fourth convolutional layers CL4, and the fourth convolutional layers CL4 may be upper layers to the third convolutional layers CL3.

The fourth convolutional layers CL4 may comprise a 4_1 convolutional layer CL4_1 and 4_2 convolutional layers CL4_2. The 4_1 convolutional layer CL4_1 may be a lower layer to the 4_2 convolutional layers CL4_2, and the 4_2 convolutional layers CL4_2 may be upper layers to the 4_1 convolutional layer CL4_1. Though FIG. 12 shows one 4_1 convolutional layer CL4_1 and N−3 number of 4_2 convolutional layers CL4_2, this is only an example and the present embodiment is not limited thereto.

In this case, the first convolutional neural network 500 may fix the parameters of some of the lower layers using the parameters determined in the first convolutional neural network 500 that was trained with the first patch image data Patch1, and may be trained using the remaining upper layers only. For example, out of the 2D convolutional layers 2D_CL, the parameters of the third convolutional layers CL3 may be fixed, and the parameters of the fourth convolutional layers CL4 may be used for training.

That is, backpropagation may be performed through the value of the prediction that has passed through the 2D convolutional layers 2D_CL, to update the parameters of the fourth convolutional layers CL4. At this time, the parameters of the third convolutional layers CL3 may be fixed, and only the parameters of the fourth convolutional layers CL4 may be updated.

The parameters of the 2D convolutional layers 2D_CL of the first convolutional neural network 500 trained with the first patch image data Patch1 and the 2D convolutional layers 2D_CL of the first convolutional neural network 500 trained with the second patch image data Patch2 may have a relatively higher similarity at lower layers. Therefore, in order to overcome the limitations of the memory 200, the parameters of the lower layers of the first convolutional neural network 500 to be trained with the second patch image data Patch2 may be fixed to the corresponding parameters of the first convolutional neural network 500 trained with the first patch image data Patch1, and only the upper layers may be used for training to minimize the usage of the memory 200.

In other words, since training the first convolutional neural network 500 with the second patch image data Patch2 uses smaller pixels as an input compared to the 2D training image data 2D data_T1 of high resolution, the usage of the memory 200 may be relatively small. Furthermore, as the parameters of the lower layers may be fixed as a result of training with the first patch image data Patch1, the usage of the memory 200 may be smaller even compared to training the first convolutional neural network 500 with all of the second patch image data Patch2.

Referring to FIG. 10 again, the first convolutional neural network is trained with all of the 2D training image data in S120.

Specifically, referring to FIG. 13, the first convolutional neural network 500 may use the parameters determined in the first convolutional neural network 500 that was trained with the first patch image data Patch1 and the second patch image data Patch2 to fix the parameters of some of the lower layers, and may be trained using only the remaining upper layers. For example, the parameters of the third convolutional layers CL3 and the 4_1 convolutional layer CL4_1 out of the 2D convolutional layers 2D_CL may be fixed, and the parameters of the 4_2 convolutional layers CL4_2 may be used for training.

The method for training a neural network and device thereof according to the present embodiments may perform backpropagation through the value of the prediction that has passed through the 2D convolutional layers 2D_CL, to update the parameters of the 4_2 convolutional layers CL4_2. At this time, the parameters of the third convolutional layers CL3 and the 4_1 convolutional layer CL4_1 may be fixed, and only the parameters of the 4_2 convolutional layers CL4_2 may be updated.

Though FIG. 13 shows that the number of lower layers whose parameters are fixed, i.e., the third convolutional layers CL3 and the 4_1 convolutional layer CL4_1 is 3 in total, and the number of upper layers whose parameter are used for training, i.e., the 4_2 convolutional layers CL4_2 is N−3, the present embodiment is not limited thereto. As the number of lower layers whose parameters are fixed increases, the usage of the memory 200 can be reduced, and thus the method for training a neural network and device thereof according to the present embodiment may appropriately select the number of lower layers whose parameters are fixed in a range that does not lower the performance of the neural network.

In this way, the memory 200 may be minimally used even in the step of processing the 2D training image data 2D data_T1.

Though the present embodiment describes processing the 2D training image data 2D data_T1 through a total of three steps by using a total of two sets of patch image data, there may be more than three steps of using the patch image data as necessary. In other words, the more the number of steps, the less the usage of the memory 200, and thus the method for training a neural network and device thereof according to the present embodiment may select an appropriate number of steps.

Referring to FIG. 2 again, the second convolutional neural network is trained using the 3D image data in S200.

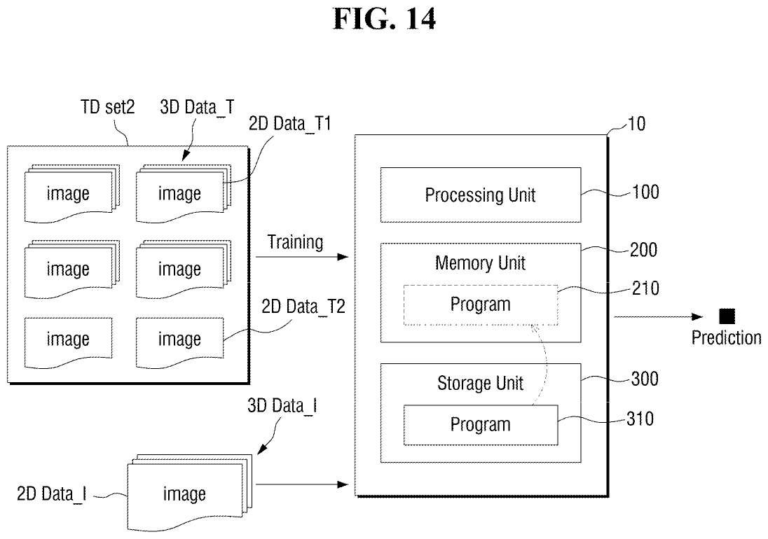

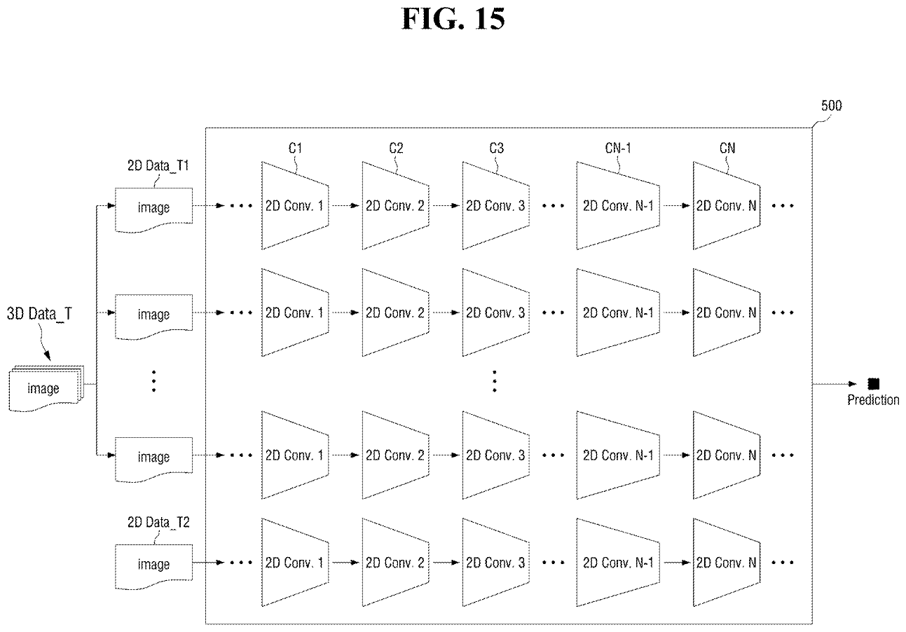

Hereinafter, a method for training a neural network and a device thereof according to some embodiments of the present invention will be described with reference to FIGS. 14 and 15. Parts that may otherwise repeat the same description will be described briefly or omitted.

FIG. 14 is a block diagram for illustrating a method for training a neural network and a device thereof according to some embodiments of the present invention, and FIG. 15 is a conceptual diagram for illustrating a method for two-dimensionally training the neural network in the method for training a neural network and device thereof shown in FIG. 14.

Referring to FIG. 14, the device 10 for training a neural network according to some embodiments of the present invention may receive a second training data set TD set2. The second training data set TD set2 may comprise at least one 3D training image data 3D data_T, and additional 2D training image data 2D data_T2. The 3D training image data 3D data_T may comprise 2D training image data 2D data_T1.

In this case, the 3D training image data 3D data_T and the additional 2D training image data 2D data_T2 may be data of different domains. Here, the domain may mean a type of data. For example, image data of different capturing methods may be data of different domains. However, the 3D training image data 3D data_T and the additional 2D training image data 2D data_T2 may be data of a somewhat high degree of similarity so as to be used together for training even if they may be of different domains.

For example, the 3D training image data 3D data_T and the 2D training image data 2D data_T1 may be data captured by a digital breast tomosynthesis (DBT) method. In this case, the additional 2D training image data 2D data_T2 may be data captured by a full-field digital mammography (FFDM) method.

Moreover, the 3D training image data 3D data_T and the 2D training image data 2D data_T1 may be computed tomography (CT) image data. In this case, the additional 2D training image data 2D data_T2 may be X-ray image data. As a matter of fact, in this case, the CT image data and the X-ray image data may be data acquired by capturing the same region. For example, if the 3D training image data 3D data_T and the 2D training image data 2D data_T1 are chest CT images, then the additional 2D training image data 2D data_T2 may be a chest X-ray image.

Referring to FIG. 15, the method for training a neural network and device thereof according to some embodiments of the present invention may train the first convolutional neural network 500 by using the 2D training image data 2D data_T1 as well as the additional 2D training image data 2D data_T2 in the course of training the first convolutional neural network 500.

In the case of neural networks, a large amount and a variety of types of data to be used for training can provide better performance. The method for training a neural network and device thereof according to some embodiments of the present invention can further improve the performance of the neural network by using data of different domains for training. Furthermore, the method for training a neural network and device thereof according to some embodiments of the present invention can improve the performance of the neural network since the amount of data used for training increases by the amount of additional 2D training image data 2D data_T2.

Though only two domains have been described in the embodiment above, this is only an example and as a matter of fact, the number of domains in the present embodiment may be three or more.

Hereinafter, a method for training a neural network and a device thereof according to some embodiments of the present invention will be described with reference to FIGS. 1 to 4 and 16. Parts that may otherwise repeat the same description will be described briefly or omitted.

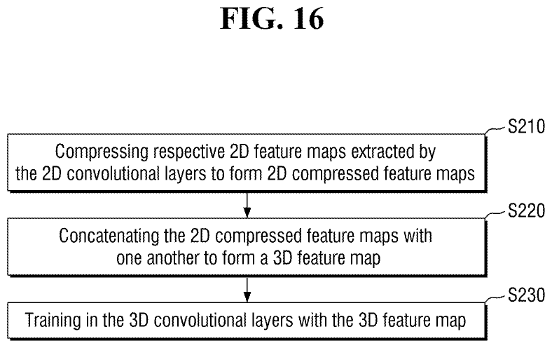

FIG. 16 is a flowchart for illustrating a method for training a neural network and a device thereof according to some embodiments of the present invention. FIG. 16 is a diagram for illustrating in detail the steps of training the second convolutional neural network shown in FIG. 2.

Referring to FIGS. 2 and 16, the method for training a neural network according to some embodiments of the present invention trains the first convolutional neural network with the 2D training image data in S100.

Thereafter, the second convolutional neural network is trained with the 3D image data in S200. At this time, the step S200 of training the second convolutional neural network may be subdivided into three steps.

First, respective 2D feature maps extracted by the 2D convolutional layers are compressed to form 2D compressed feature maps in S210.

Referring to FIG. 4 in particular, the 2D feature maps that are the output derived from the plurality of 2D training image data 2D data_T1 by passing through the 2D convolutional layers 2D_CL are respectively compressed. In this case, the compression method for the 2D feature maps may vary. For example, the second convolutional neural network 510 may be used to perform convolution in a 1×1 unit or a unit of different sizes, to thereby compress the 2D feature maps. However, the present embodiment is not limited thereto.

Referring to FIG. 16 again, the 2D compressed feature maps are concatenated with one another to form a 3D feature map in S220.

The 2D compressed feature maps may be concatenated in the order of the 2D training image data 2D data_T1 from which the respective 2D compressed feature maps are derived. In this way, the 3D convolutional layer 3D_CL may be used to learn context information.

Thereafter, the 3D convolutional layer is trained with the 3D feature map in S230.

Referring to FIG. 1 and FIG. 4 in particular, if the 3D convolutional layer 3D_CL is used for training with the 3D feature map formed by concatenating uncompressed 2D feature maps with one another as they are, the usage of the memory 200 and a computational amount may be very high. Accordingly, the size of the 3D feature map can be reduced by compressing each of the 2D feature maps.

The method for training a neural network and device thereof according to the present embodiment can compress each of the 2D feature maps to form a 3D feature map of relatively small size, so as to reduce the usage of the memory 200 and the amount of computation, to thereby improve the performance of the neural network.

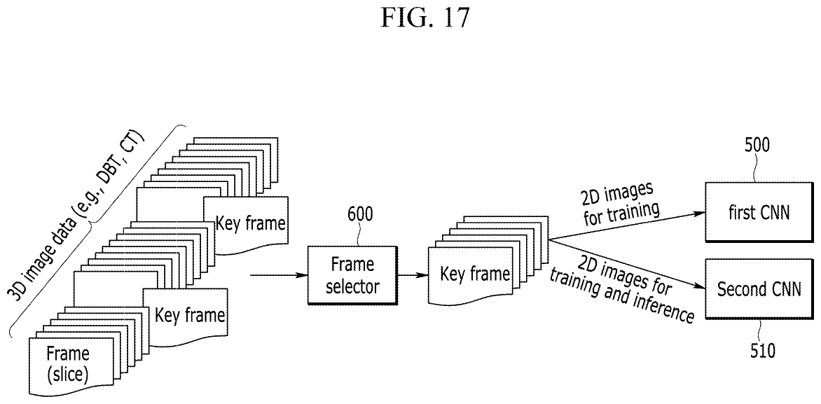

FIG. 17 is a diagram for illustrating frame selection for 3D image data according to some embodiments of the present invention.

Referring to FIG. 17, the device 10 may train the first convolutional neural network (CNN) 500 using 2D images, and may also train the second CNN 510 using 2D images constituting 3D image data. Here, the first CNN 500 may be trained using the 2D images constituting 3D image data (e.g., DBT, CT), may be trained using 2D images acquired from different domains (e.g., FFEM, X-ray) from the 3D image data, or may be trained using the 3D image data with additional 2D images acquired from the different domain. Similarly, the second CNN 510 may be trained using the 2D images constituting the 3D image data, or may be trained using the 3D image data with the additional 2D images acquired from the different domains. Accordingly, the device 10 may be smoothly operated even with a low memory capacity without decreasing performance by using 3D image data of high resolution.

Meanwhile, the 3D image data acquired by DBT or CT, may comprise a plurality of frame images (e.g., 60 to 100 frame images), and the difference between frames, especially the difference between adjacent frames, is not significant. However, the resolution of each frame image is more than 2400×2000 pixels, and particularly the resolution of high-resolution frame images is very high, such as 4000×3000 pixels, so it is important to reduce computation. Here, the frame image refers to the 2D image that constitutes the 3D image data. It is a term used to distinguish from the 2D images acquired by 2D imaging devices such as Full-Field Digital Mammography (FFDM), and may also be simply referred to as a frame or slice.

All frame images constituting the 3D training image data 3D Data_T may be used as training data for the first CNN 500 or the second CNN 510. Alternatively, considering the characteristics of the 3D image data, instead of using all frame images constituting the 3D training image data 3D Data_T as training data for the first CNN 500 or the second CNN 510, some key frame images may be used as training data to reduce computing resources and increase computing speed.

When inferring on 3D inference image data 3D Data_I that is an inference target, all frame images constituting the 3D inference image data 3D Data_I may be input into the trained second CNN 510 to obtain predictions for the 3D inference image data 3D Data_I. Alternatively, key frame images selected from the 3D inference image data 3D Data_I may be input into the trained second CNN 510 to obtain predictions for the 3D inference image data 3D Data_I.

Since the 3D image data comprises similar frame images, it is possible to improve the performance through training or inferring using the selected key frame images rather than training or inferring using all the frame images.

The device 10 may comprise a frame selector 600. The frame selector 600 may select key frame images that affect predictions from frame images included in the 3D image data through various frame selection methods. The first CNN 500 or the second CNN 510 may train or infer using the selected key frame images from the 3D image data, and may not use the unselected frame images for training or inference. For example, the frame selector 600 may receive a DBT image consisting of a plurality of Tomo slices per view (e.g., RCC, RMLO, LCC, LMLO) and select a certain number of Tomo slices containing key information.

The frame selector 600 may be implemented to provide the selected key frame images to the first CNN 500 or the second CNN 510. In addition to the first CNN 500 or the second CNN 510, the frame selector 600 may be used to select input images for various types of artificial intelligence (AI) models.

The frame selector 600 can randomly select certain frame images from the 3D image data. For example, the frame selector 600 may receive a DBT image comprising N number of Tomo slices per view and select M (M<N) number of Tomo slices. The first CNN 500 or the second CNN 510 may receive input of randomly selected images per view, and may train tasks using the input images or perform predictions on the 3D image data using the input images.

The frame selector 600 may select center frame images of the 3D image data as the key frame images. For example, the frame selector 600 may receive a DBT image comprising N number of Tomo slices per view and select center Tomo slices. The frame selector 600 may select M (M<N) number of images located in the middle of total N images as the key frame image. The first CNN 500 or the second CNN 510 may receive input of the selected M images per view, and may train tasks using the input images or perform predictions on the 3D image data using the input images.

The frame selector 600 may select suspicious frame images from the 3D image data as key frame images. For example, the frame selector 600 may receive a DBT image comprising N number of Tomo slices per view and select suspicious Tomo slices having a lesion suspicion level above a threshold. The frame selector 600 may comprise a model that determines the lesion suspicion level of the input image, or may select suspicious frame images based on the output of a separate model that determines the lesion suspicion level of the input image. The first CNN 500 or the second CNN 510 may receive input of the selected suspicious frame images per view, and may train tasks using the input images or perform predictions on the 3D image data using the input images. The frame selector 600 may additionally select non-suspicious frame images from the 3D image data along with the suspicious frame images, and provide the selected images as key frame images.

In the case of DBT images, lesions are not detected in all slices. Therefore, most slice images serve as negative training data without lesions. By selecting suspicious frame images, the number of positive training data with lesions can be increased, and as a result, the AI model may be trained more efficiently.

The frame selector 600 may select annotated frame images from the 3D image data as key frame images. For example, the frame selector 600 may receive input a DBT image comprising N number of Tomo slices per view and select annotated Tomo slices with annotations or labels. The first CNN 500 or the second CNN 510 may receive input of the annotated frame images per view and train tasks using the input images or perform predictions on the 3D image data using the input images. Here, the annotations may be obtained through a labeling task in which an annotator (e.g., a radiologist) find and marks lesions in medical images. By using the images selected through frame image selection as training data, it is not necessary to annotate all frame images of 3D image data, and the AI model can be trained with annotations of a small number of frame images. Therefore, the annotation budget may be reduced.

Meanwhile, the frame selector 600 does not necessarily select only the center frame images, the suspicious frame images, or the annotated frame images as key frame images, but may select additional images around them as key frame images and provide the selected images to the first CNN 500 or the second CNN 510.

In this way, when the first CNN 500 or the second CNN 510 may train or infer using 2D images included in 3D image data, training or inference may be performed using only the selected images, which can reduce training time or inference time, reduce resources required for training or inference, and be able to analyze images with higher resolution due to reduced computations. Furthermore, when the second CNN 510 may train or infer using 3D image data, instead of using entire frame images, the second CNN 510 may train or infer using key frame images that contain important information that affects the prediction, allowing for efficient learning and improve prediction performance.

The method of training or inferring using key frame images by the first CNN 500 or the second CNN 510 may be implemented according to the various embodiments described in FIGS. 1 to 17.

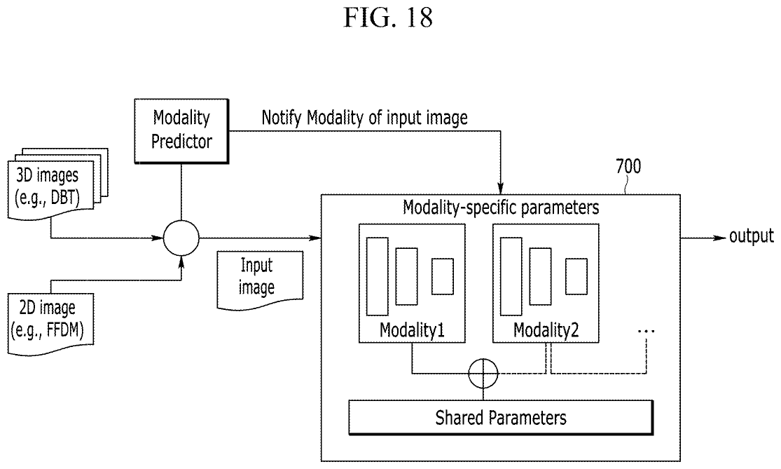

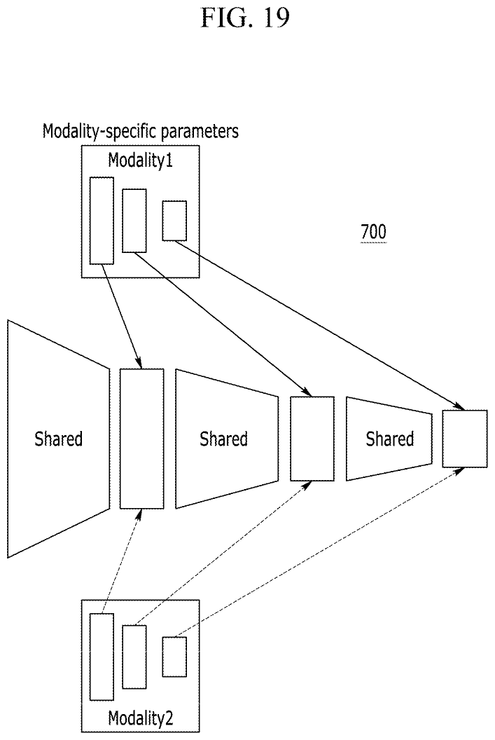

FIG. 18 is a diagram for illustrating AI model switching according to some embodiments of the present invention, and FIG. 19 is a conceptual diagram for illustrating adaptation of modality-specific parameters according to some embodiments of the present invention.

Referring to FIG. 18, AI model 700 is a model trained to receive images as input and output results inferred from the input images. The input images to AI model 700 may be images obtained from different imaging modalities. For example, the input image to AI model 700 may be an image obtained from a 3D DBT imaging modality or an image obtained from a 2D FFDM imaging modality. For 2D imaging modalities, one image is typically obtained per view (i.e., RCC, LCC, RMLO LMLO), while for 3D imaging modalities, multiple images may be obtained per view.

To enable a single AI model 700 to effectively and accurately analyze images obtained from different imaging modalities, i.e., images obtained from heterogeneous domains, the AI model 700 is configured to use modality-specific parameters along with shared parameters. The AI model 700 may store parameter sets including modality-specific parameters, distinguished by modality, and may be configured to selectively use each parameter set depending on the type of modality of the input images. By combining the modality-specific parameters corresponding to the modality of the input images with the shared parameters, the AI model 700 may adaptively switch the parameters according to the modality of the input images. Here, the shared parameters may be a foundation model trained using various types of images, and may be a large-scale model or a pretrained model that can generate features for various tasks.

The AI model 700 may receive modality information of the input image from modality predictor 800. The modality predictor 800 checks the input image to the AI model 700 and identifies the modality type of the input image. The modality predictor 800 may be a model trained to determine the type of modality based on metadata of the DICOM file, the shape of the image, or the number of images. The modality predictor 800 may notify the modality of the input image to the AI model 700.

Generally, it is not easy to train a single model using different domain data obtained from different modalities, and it is difficult to guarantee its performance. To address this, during the training of AI model 700, the shared parameters are fixed, and the modality-specific parameters are updated according to the input, so that a parameter set distinguished by modality can be obtained.

Referring to FIG. 19, when the AI model 700 may receive a notification from the modality predictor 800 that the input images are of modality 1 (e.g., a 3D modality such as DBT), the AI model 700 may construct designated layers by modality-specific parameters trained using images of modality 1. The AI model 700 may switch to a model where the modality-specific parameters for the modality 1 are adapted to the shared parameters.

When the AI model 700 may receive a notification from the modality predictor 800 that the input images are of modality 2 (e.g., a 2D modality such as FFDM), the AI model 700 may construct the designated layers by modality-specific parameters trained using images of modality 2. The AI model 700 may switch to a model where the modality-specific parameters for the modality 2 are adapted to the shared parameters.

This AI model switching may be provided by implementing some layer as fixed with the shared parameters, and some layers as variable with selected modality-specific parameters, in the total layers of the AI model.

Here, the AI model 700 may comprise convolutional layers, such as the first CNN 500 or the second CNN 510, wherein the parameters of some 2D convolutional layers are fixed and the parameters of the remaining 2D convolutional layers are obtained through training with modality-specific images. The AI model 700 may be implemented as a mixed form of a neural network trained with 2D images obtained by 2D imaging devices such as FFDM and a neural network trained with 2D images obtained by a 3D imaging device such as DBT. The network may be configured variably depending on the modality of the input image.

Thus, the parameters fixed during training with modality-specific images may be the shared parameters and the parameters being trained may be the modality-specific parameters. The shared parameters and the modality-specific parameters may be obtained according to various embodiments described in FIGS. 1 to 17.

Meanwhile, the AI model 700 may be modified to suit the modality using Low Rank Adaptation. When the AI model 700 is trained using modality-specific images, the AI model 700 may add modality-specific parameters to the shared parameters for training. In this case, the modality-specific parameters consist of two matrices, and by adjusting the rank of each matrix, the number of parameters participating in training can be reduced to make learning more efficient. When the AI model 700 infers, the AI model 700 may add the matrix multiplication of the two matrices to the shared parameters.

In addition, the AI model 700 may have only modality-specific parameters that may be varied without shared parameters. The AI model 700 may further include a classifier to classify features obtained by the shared parameters.

The 3D DBT images and the 2D FFDM images or the 3D CT images and the 2D X-ray images are complementary to each other. While 2D images have less information but are easier to obtain and process, 3D images have more information about a single case. Therefore, since the single AI model 700 may analyze inputs from different modalities, it can enhance user convenience and take advantage of the benefits of each modality. In addition, by using data from different modalities for learning, data utility can be maximized.

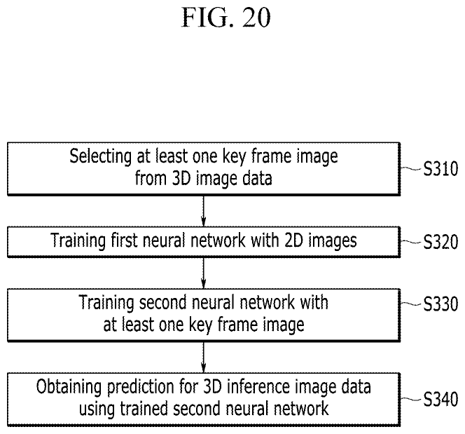

FIG. 20 is a diagram for illustrating a neural network training and inference method based on frame selection for 3D images according to some embodiments of the present invention.

Referring to FIG. 20, the device 10 may select at least one key frame image from 3D image data (S310). The 3D image data may comprise at least one of a digital breast tomosynthesis (DBT) image or a computed tomography (CT) image, and the additional 2D image comprises at least one of a full-field digital mammography (FFDM) image or an X-ray image. The at least one key frame image may comprise at least one randomly selected image from the 3D image data comprising a plurality of 2D images, at least one center frame image selected from the 3D image data, at least one suspicious frame image selected from the 3D image data, or at least one annotated frame image selected from the 3D image data.

The device 10 may train a first neural network with 2D images (S320). The first neural network may comprise a plurality of 2D convolutional layers. The 2D images used for training the first neural network may comprise the at least one key frame image selected from the 3D image data, and/or additional 2D images obtained from a different domain from the 3D image data.

The device 10 may train a second neural network with the at least one key frame image (S330). The second neural network may comprise the plurality of 2D convolutional layers, and an aggregator combining outputs of the 2D convolutional layers.

The device 10 may obtain a prediction for 3D inference image data using the trained second neural network (S340). The device 10 may input full images of the 3D inference image data comprising a plurality of 2D images to the trained second neural network, and obtain the prediction for the 3D inference image data, inferred from the trained second neural network.

Also, the device 10 may input at least one target key frame image selected from the 3D inference image data to the trained second neural network, and obtain the prediction for the 3D inference image data, inferred from the trained second neural network.

The parameters of one or more 2D convolutional layers among the 2D convolutional layers may be fixed during the training of the second neural network, and parameters of one or more remaining 2D convolution layers among the 2D convolutional layers may be trained with the at least one key frame image during the training of the second neural network.

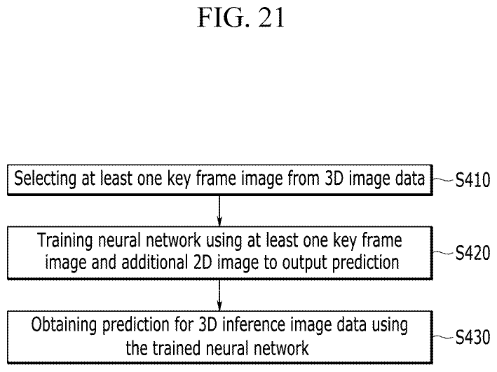

FIG. 21 is a diagram for illustrating a neural network training and inference method based on frame selection for 3D images according to some embodiments of the present invention.

Referring to FIG. 21, the device 10 may select at least one key frame image from 3D training image data comprising a plurality of two-dimensional (2D) images (S410). The neural network may comprise the plurality of 2D convolutional layers, and an aggregator combining outputs of the 2D convolutional layers.

The device 10 may train a neural network using the at least one key frame image and at least one additional 2D image to output a prediction (S420). The additional 2D image may be obtained from a different domain from the 3D training image data.

The device 10 may obtain a prediction for 3D inference image data using the trained neural network (S430). The device 10 may input full images of the 3D inference image data comprising a plurality of 2D images to the trained neural network, and obtain the prediction for the 3D inference image data, inferred from the trained neural network. Also, the device 10 may input at least one target key frame image selected from the 3D inference image data to the trained second neural network, and obtain the prediction for the 3D inference image data, inferred from the trained neural network.

The 3D image data may comprise at least one of a digital breast tomosynthesis (DBT) image or a computed tomography (CT) image, and the additional 2D image may comprise at least one of a full-field digital mammography (FFDM) image or an X-ray image.

The plurality of 2D convolutional layers may be pre-trained using a plurality of 2D training images. During the training the neural network, parameters of one or more 2D convolutional layers among the 2D convolutional layers may be fixed and parameters of one or more remaining 2D convolution layers among the 2D convolutional layers may be trained with the at least one key frame image. The plurality of 2D training images may comprise the at least one key frame image selected from the 3D image data, and/or 2D images obtained from a different domain from the 3D image data. The plurality of 2D training images may comprise the at least one key frame image selected from the 3D image data, and/or 2D images obtained from a different domain from the 3D image data.

Although embodiments of the present invention have been described above with reference to the accompanying drawings, it will be understood by those having ordinary skill in the art to which the present invention pertains that the present invention can be implemented in other specific forms without changing the technical spirit or essential features thereof. Therefore, it should be understood that the embodiments described above are exemplary in all respects and not restrictive.

What is claimed is:

1. A method for training a neural network with three-dimensional (3D) image data by a processor, the method comprising:
selecting at least one key frame image from 3D image data;
training a first neural network with two-dimensional (2D) images, wherein the first neural network comprises a plurality of 2D convolutional layers;
training a second neural network with the at least one key frame image,
wherein the second neural network comprises the plurality of 2D convolutional layers, and an aggregator combining outputs of the 2D convolutional layers, and
wherein the 2D images used for training the first neural network comprise the at least one key frame image selected from the 3D image data, and/or additional 2D images obtained from a different domain from the 3D image data.

2. The method of claim 1, wherein the 3D image data comprises at least one of a digital breast tomosynthesis (DBT) image or a computed tomography (CT) image, and the additional 2D image comprises at least one of a full-field digital mammography (FFDM) image or an X-ray image.

3. The method of claim 1, wherein parameters of one or more 2D convolutional layers among the 2D convolutional layers are fixed during the training of the second neural network, and parameters of one or more remaining 2D convolution layers among the 2D convolutional layers are trained with the at least one key frame image during the training of the second neural network.

4. The method of claim 1, wherein the at least one key frame image comprise at least one randomly selected image from the 3D image data comprising a plurality of 2D images, at least one center frame image selected from the 3D image data, at least one suspicious frame image selected from the 3D image data, or at least one annotated frame image selected from the 3D image data.

5. The method of claim 1, further comprising:
obtaining a prediction for 3D inference image data using the trained second neural network.

6. A method for training a neural network with three-dimensional (3D) image data by a processor, the method comprising:
selecting at least one key frame image from 3D training image data comprising a plurality of two-dimensional (2D) images;
training a neural network using the at least one key frame image and at least one additional 2D image to output a prediction,
wherein the additional 2D image is obtained from a different domain from the 3D training image data.

7. The method of claim 6, wherein the selecting at least one key frame image comprises to select the at least one key frame image randomly from the plurality of 2D images.

8. The method of claim 6, wherein the selecting at least one key frame image comprises to select at least one center frame image from the plurality of 2D images, as the at least one key frame image.

9. The method of claim 6, wherein the selecting at least one key frame images comprises to select at least one suspicious frame image from the plurality of 2D images, as the at least one key frame image.

10. The method of claim 6, wherein the selecting at least one key frame image comprises to select at least one annotated frame image from the plurality of 2D images, as the at least one key frame image.

11. The method of claim 6, wherein the 3D image data comprises at least one of a digital breast tomosynthesis (DBT) image or a computed tomography (CT) image, and the additional 2D image comprises at least one of a full-field digital mammography (FFDM) image or an X-ray image.

12. The method of claim 6, further comprising:
obtaining a prediction for 3D inference image data using the trained neural network.

13. The method of claim 6, wherein the neural network comprises the plurality of 2D convolutional layers, and an aggregator combining outputs of the 2D convolutional layers.

14. The method of claim 13, wherein the plurality of 2D convolutional layers are pre-trained using a plurality of 2D training images.

15. The method of claim 14, wherein, during the training the neural network, parameters of one or more 2D convolutional layers among the 2D convolutional layers are fixed and parameters of one or more remaining 2D convolution layers among the 2D convolutional layers are trained with the at least one key frame image.

16. The method of claim 14, wherein the plurality of 2D training images comprise the at least one key frame image selected from the 3D image data, and/or 2D images obtained from a different domain from the 3D image data.

17. A device comprising:
a memory configured to store computer-executable instructions; and
a processor configured to execute the computer-executable instructions to:
obtain three-dimensional (3D) inference image data comprising a plurality of two-dimensional (2D) images; and
input at least one of the plurality of 2D images constituting the 3D inference image data to a neural network to obtain a prediction for the 3D inference image data,
wherein the neural network is trained using at least one key frame image selected from 3D training image data, and at least one additional 2D image, and
wherein the additional 2D image is obtained from a different domain from the 3D training image data

18. The device of claim 17, wherein the processor is further configured to input 2D inference image data to the neural network to obtain a prediction for the 2D inference image data.

19. The device of claim 17, wherein the 3D inference image data or the 3D training image data comprises at least one of a digital breast tomosynthesis (DBT) image or a computed tomography (CT) image, and the additional 2D image comprises at least one of a full-field digital mammography (FFDM) image or an X-ray image.

20. The device of claim 17, wherein the processor is further configured to select at least one target key frame image from the 3D inference image data comprising the plurality of 2D images and
wherein in inputting the at least one of the plurality of 2D images, the processor is configured to:
input the at least one target key frame image to the neural network to obtain the prediction for the 3D inference image data.
